(19) United States
(12) Patent Application Publication
(10) Pub. No.: US 2015/0142822 A1
(43) Pub. Date: May 21, 2015

(54) METHOD AND APPARATUS FOR PROVIDING CROWD-SOURCED GEOCODING

(71) Applicants: Wenwei Xue, Beijing (CN); Hao Yang, San Jose, CA (US)

(72) Inventors: Wenwei Xue, Beijing (CN); Hao Yang, San Jose, CA (US)

(73) Assignee: Nokia Corporation

(21) Appl. No.: 14/411,310

(22) PCT Filed: Aug. 10, 2012
(86) PCT No.: PCT/CN2012/079916

§ 371 Date: Dec. 24, 2014

(51) Int. Cl. G06F 17/30

(52) U.S. Cl. CPC G06F 17/3087
USPC 707/743; 707/754

(57) ABSTRACT

An approach is provided for providing crowd-sourced location geocoding. A geocoding platform determines one or more location strings associated with at least one event, wherein the at least one event is associated with one or more users. The geocoding platform further causes, at least in part, a geocoding of the one or more location strings to determine location information associated with the at least one event based, at least in part, on one or more inputs, contextual information, a combination thereof associated with the one or more users.

### BACKGROUND

Service providers and device manufacturers (e.g., wireless, cellular, etc.) are continually challenged to deliver value and convenience to consumers by, for example, providing compelling network services. One such service is geocoding, which is the ability to determine location information, such as geographic coordinates, from other information, such as a textual string including or describing geographic data. Although such geocoding services have become powerful, the services still suffer from returning empty or erroneous results in response to geocoding queries. Accordingly, service providers and device manufacturers face significant technical challenges in providing effective geocoding results.

### SOME EXAMPLE EMBODIMENTS

Therefore, there is a need for an approach for providing crowd-sourced location geocoding.

According to one embodiment, a method comprises determining one or more location strings associated with at least one event, wherein the at least one event is associated with one or more users. The method also comprises causing, at least in part, a geocoding of the one or more location strings to determine location information associated with the at least one event based, at least in part, on one or more inputs, contextual information, or a combination thereof associated with the one or more users.

According to another embodiment, an apparatus comprises at least one processor, and at least one memory including computer program code for one or more computer programs, the at least one memory and the computer program code configured to, with the at least one processor, cause, at least in part, the apparatus to determine one or more location strings associated with at least one event, wherein the at least one event is associated with one or more users. The apparatus is also caused to geocode the one or more location strings to determine location information associated with the at least one event based, at least in part, on one or more inputs, contextual information, or a combination thereof associated with the one or more users.

According to another embodiment, a computer-readable storage medium carries one or more sequences of one or more instructions which, when executed by one or more processors, cause, at least in part, an apparatus to determine one or more location strings associated with at least one event, wherein the at least one event is associated with one or more users. The apparatus is also caused to geocode the one or more location strings to determine location information associated with the at least one event based, at least in part, on one or more inputs, contextual information, or a combination thereof associated with the one or more users.

According to another embodiment, an apparatus comprises means for determining one or more location strings associated with at least one event, wherein the at least one event is associated with one or more users. The apparatus also comprises means for causing, at least in part, a geocoding of the one or more location strings to determine location information associated with the at least one event based, at least in part, on one or more inputs, contextual information, or a combination thereof associated with the one or more users.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: an apparatus comprising means for performing the method of any of originally filed claims 1-15, 31-45, and 51-53.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing crowd-sourced location geocoding, according to one embodiment;

FIG. 2 is a diagram of the components of a geocoding platform, according to one embodiment;

FIG. 3 is a flowchart of a process for providing crowd-sourced location geocoding, according to one embodiment;

FIG. 4 is a flowchart of a process for providing crowd-sourced location geocoding based on one or more location trajectories, according to one embodiment;

FIG. 5 is a flowchart of a process for determining location trajectories based on timing information, according to one embodiment;

FIG. 6 is a flowchart of a process for determining contextual information based on timing information for providing crowd-sourced location geocoding, according to one embodiment;

FIG. 7 is a flowchart of a process for providing crowd-sourced location geocoding based on one or more user votes, according to one embodiment;

FIGS. 8A-8D are diagrams of user interfaces utilized in the processes of FIGS. 3-7, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for providing crowd-sourced location geocoding are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term location string refers to a string of information that includes data and/or information representing and/or including one or more geographic locations. Thus, by way of example, a location string may be an address string entered by a user in a location field associated with a calendar item, or an address string in an email, an SMS message, a MMS message, or another form of communication. The location string may also be data associated with an image, an audio clip, a video clip, or the like that may be processed to determine a geographic location associated with the image, the audio clip, or the video clip. For example, image processing techniques may be able to determine a location associated with an image based on the underlying information (e.g., location string) that is associated with the data that embodies the image.

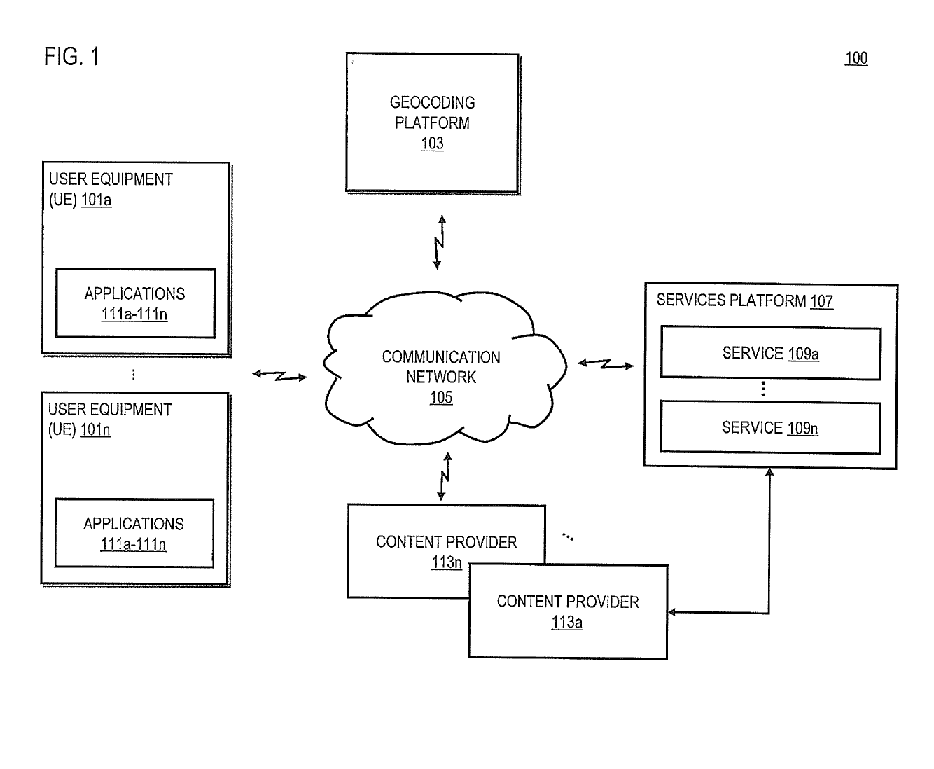

FIG. 1 is a diagram of a system capable of providing crowd-sourced location geocoding, according to one embodiment. Current service providers and/or device manufacturers have developed services that provide geocoding to determine location information (e.g., geographic coordinates) from location strings. Further, such geocoding services have become integrated with certain applications to provide the geocoding services integrated with other services. For example, a calendar item (e.g., a meeting, an appointment, etc.) commonly has a location field where the user can enter information to describe a location associated with the calendar item. The location field is often associated with a free textual input by the user. The calendar item may be integrated with a geocoding service that may process the location field to attempt to determine the location information associated with any location entered in the field. The location string in the location field may then be modified to include or represent a hyperlink that the user may select to have a map presented that illustrates the location information (e.g., geographic coordinates) the geocoding service determined as being correlated to the textual string entered in the location field. However, issues can arise with respect to such integrated geocoding services.

For example, although a user may enter a location string into the location field, the geocoding service may be unable to determine the location information associated with the location string. Thus, no hyperlink may be added to the location string. Further, the geocoding service may determine geographic coordinates that do not accurately reflect the intended location entered by the user in the location field. Thus, although a hyperlink may be added to the text of the location field, the hyperlink may be associated with the wrong location. Based on these two examples, the geocoding services integrated with other applications, and geocoding services in general, may actually negatively affect a user's experience. A user may be surprised to see the location field updated to include a hyperlink to a map illustrating the determined geographic coordinates, only to be later disappointed when the user determines the geographic coordinates are incorrect.

Particularly where the geocoding services are integrated with other applications, such as calendar applications and/or communication applications (e.g., email, SMS, MMS, etc.), the reason for the user entering a location string associated with a location of an event may be different than the reason a user enters a location string into a standalone geocoding query field. When a user enters a location string into a standalone geocoding query field, the user understands that the better and/or more accurate the location string is, the better the results will be of the geocoding query. Such is not the case when the user enters a location string into a location field of a calendar item and/or in the text of a communication. In the latter situation, the user may enter the location string mainly for noting, marking and/or reminding purposes. The user may use shorthand and/or other abbreviation techniques for the user to personally remember the location associated with the event. That a calendar may be integrated with geocoding services that can translate the location string to hyperlinked geographic coordinates may not be a motivation for the user to enter a location string into a location field of a calendar item (or any location string for any other use). Thus, the location string may be in a less formal, freestyle, incomplete and/or inaccurate format or description. For example, the location strings may be focused on landmarks and/or points of interest that are not necessarily described such that a geocoding service can process the location string. Where the location string is: at the red barn on 4th St., even if the geocoding service can accurately determine the subject of the location string, there may be many red barns near a street named 4th street within the geographic area covered by the geocoding service. Thus, the location strings may be entered with respect to personal information of the user and/or users that are associated with an event that is tied to the particular location that may be otherwise undeterminable by a geocoding service.

Further, indoor locations are common for many events, such as meetings for work or meetings with friends at a mall or a concert venue. As service providers and device manufactures continue to develop mapping services, more mapping services with respect to indoor locations are being provided. However, such indoor locations suffer from the same problems, if not to a greater extent, as location strings not being readably processed to determine the corresponding location information because descriptions of indoor location may be even less formal or less tied to a common format. Thus, the above geocoding services are primarily useless with respect to indoor locations.

To address these problems, a system 100 of FIG. 1 introduces the capability to determine one or more location strings associated with at least one event, with the at least one event being associated with one or more users. The system 100 further introduces the ability to cause a geocoding of the one or more location strings to determine location information associated with the at least one event based on one or more inputs, contextual information, or a combination thereof associated with the one or more users. Accordingly, the system 100 allows for crowd-sourced location maintenance and geocoding for location strings that may be associated with an event. The system 100 may utilize the prior knowledge or contextual information of users participating in an event that is associated with one or more locations strings to determine the location information associated with the event. The users associated with an event may manually enter the location information based on one or more inputs and/or based on the contextual information of the users.

The location strings may include one or more characters (e.g., letters, numbers, other symbols, etc.) that describe location information. The location strings may be created by the user and thus be personalized descriptions of the location information. Alternatively, the location strings may be descriptions of location information according to one or more customary description formats. By way of example, the location strings may be formatted according to a postal address, such as by including a street number followed by a street, a city, a state and a zip code, where the location string is associated with a postal address in the United States of America. The location strings also may be less formal than such postal addresses, such as by merely including information regarding a landmark, a point-of-interest, etc. that may be associated directly and/or indirectly with location information. The location string may also be written as a note for a user such that the location string is only loosely tied to some form of indication of location information, such as being loosely tied to a postal address. By way of example, the location string may be “Grandma's house”, which is loosely tied to the location of grandma's house only through the knowledge of the user associated with the grandma.

The location string may be by itself, such as in a geocoding query, or may be found and/or integrated within one or more applications 111 executed at the UE 101. For example, the location string may be sent directly to the geocoding platform 103 in a query from a geocoding manager application 111a at the UE 101. Further, the location string may be found in a communication, such as an email, an SMS message, a MMS message, etc. The location string may be extracted from the communication using, for example, natural language processing techniques. Further, the location string may be associated with any other item at the UE 101, such as a calendar item that may include a location field. The location field may be filled with the location string so that one or more users associated with the calendar item are reminded of a location associated with calendar item.

As shown in FIG. 1, the system 100 comprises user equipment (UE) 101a-101n (collectively referred to as UE 101) having connectivity to a geocoding platform 103 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, near field communication (NFC), Internet Protocol (IP) data casting, digital radio/television broadcasting, satellite, mobile ad-hoc network (MANET), and the like, or any combination thereof.

The UE 101 is any type of mobile terminal, fixed terminal, or portable terminal including a mobile handset, station, unit, device, mobile communication device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

The UE 101 may include one or more applications 111a-111n (collectively referred to as applications 111). The applications 111 may be any type of application that may perform one or more processes and/or functionality at the UE 101. By way of example, the applications may include calendar applications, social networking applications, communication applications (e.g., email, SMS, MMS, voicemail, voice-to-text, etc.), mapping applications, Internet browsing applications, information provisioning applications (e.g., news, weather, etc.), and the like. As discussed above, one or more of the applications may be associated with the geocoding platform 103 to perform one or more processes and/or functionality associated with the geocoding platform 103 at the UE 101. For example, the one or more applications 111 associated with the geocoding platform 103 may be a geocoding manager application 111a. In one embodiment, the geocoding platform 103 may be completely embodied by one or more applications 111, such as the geocoding manager application 111a at the UE 101.

In one embodiment, for example, a calendar application 111b may execute at the UE 101. The calendar application 111b may allow for a user to create a calendar item, such as an appointment, a meeting, an email, and the like. The calendar item may include a location field where a user may enter a location string that describes the location associated with the appointment and/or meeting. Alternatively, the communication may include a location string where, for example, the user is describing a location within the communication. The location string may then be processed as discussed below to determine the geographic coordinates associated with the location represented by the location string.

In another embodiment, an email application 111c may execute at the UE 101. The email application 111c may allow for a user to create an email that may be sent to one or more recipients. Within the email, that user may include a location string where, for example, the email is regarding an event associated with a specific location. Using natural language processing techniques, the location string may be extracted from the body of the email. The location string may then be processed as discussed below to determine the geographic coordinates associated with the location represented by the location string.

The system 100 may further include a services platform 107 that may include one or more services 109a-109n (collectively referred to as services 109). The services 109 may be any type of service that may be provided to the UE 101 and/or geocoding platform 103, such as contextual information services, mapping services, calendar services, etc. In one embodiment, the services 109 may include a geocoding service 109a that may provide the back-end geocoding for the geocoding platform 103, such as an initial list of geocoding results that may be modified by the geocoding platform 103 according to one or more user inputs and/or contextual information associated with one or more users. Further, in one embodiment, the services 109 may include natural language processing services and/or named entity recognition services 109b. As discussed above, the natural language processing services 109b may determine one or more location strings from a body of text, such as from an email, an SMS, a memo, etc. By way of example, an email may recite:
We have a meeting with Prof. Wang in Room 4038, Central Main Building, Tsinghua University this afternoon at 14:00 PM. Let's take a taxi from Nokia China Campus to go together at 12:30 PM.

Based on the natural language processing, the location strings of: “Room 4038, Central Main Building, Tsinghua University” and “Nokia China Campus” may be extracted from the email. Further, additional natural language processing techniques may be used to extract, for example, timing information from a body of text. Thus, in the above example, the text strings of: “this afternoon at 14:00 PM” and “at 12:30 PM” may be extracted from the email. The time information may be further utilized as discussed below in geocoding the location strings.

The system 100 may further include one or more content providers 113a-113n (collectively referred to as content providers 113). The content providers 113 may provide content to the UE 101, the geocoding platform 103 and/or one or more of the services 109 on the services platform 107. The content may be any type of content, such as location information regarding points of interest, landmarks, new address information correlated to geographic points of interest, etc.

The geocoding platform 103 provides crowd-sourced location geocoding for the elements within the system 100, such as the UE 101 and/or the services 109. In one embodiment, the geocoding platform 103 causes a geocoding of one or more location strings to determine location information associated with an event based on one or more inputs associated within one or more users. In one embodiment, the inputs may be associated with entering a geographic location and/or geographic coordinates. For example, based on a location string, the geocoding platform 103 may be unable to determine corresponding geographic coordinates. A user may then manually input the geographic coordinates associated with the location string. The manual input may be based on, for example, a user entering longitude and latitude coordinates, placing a marker on a presentation of a map, or the like. In one embodiment, where the geocoding platform 103 is unable to determine the geographic coordinates associated with a location string, the geocoding platform 103 may initially estimate that the geographic coordinates as the current coordinates associated with the user, which the user may then modify to indicate the accurate geographic coordinates that reflect the location string. The geocoding platform 103 may determine the current coordinates of the user based on contextual information associated with the user. For example, the geocoding platform 103 may determine location contextual information associated with a user based on GPS information associated with a user's UE 101a. The user may then modify the determined coordinates by indicating on a presentation of a map where on the map the location string is associated with.

In one embodiment, rather than the geocoding platform 103 being unable to determine location information (e.g., geographic coordinates) that are associated with a location string, the geocoding platform 103 may rather determine multiple geographic coordinates that may be associated with a location string. According to the above procedure, a user may determine which one of the multiple geographic coordinates accurately reflect the location string. The user may indicate the accurate geographic coordinates by selecting one of the multiple results determined by the geocoding platform 103. In one embodiment, the user may select one of the multiple results by selecting on a presentation of a map the accurate geographic coordinates.

In one embodiment, one or more location strings may be created by one or more users that are associated with the same event. Such an event may include, for example, an activity that a group of users are all participating in. Where the geocoding platform 103 is unable to determine geographic coordinates associated with a location string, or determines multiple possible geographic coordinates associated with a location string, one user from the group of users may initially indicate or select geographic coordinates that represent the location string. Subsequently, the geocoding platform 103 allows for other users of the group of users to indicate their approval of the indicated or selected geographic coordinates. By way of example, the geocoding platform 103 may allow users to vote as to whether the users agree that the indicated or selected geographic coordinates accurately match with the location string. The other users may be able to see the votes to see what the other users believe is the geographic coordinates that correlate to the location string.

In one embodiment, all of the users, including the initial user who indicated or selected the initial geographic coordinates could vote to determine which geographic coordinates correlate to the location string. For example, the initial user to correlate geographic coordinates with the location string may not be completely confident that he is correct. Accordingly, rather than indicating or selecting geographic coordinates (e.g., indicating from an initial return of no geographic coordinates or selecting from a list of multiple geographic coordinates), the user may vote that a selected geographic coordinate correlates to the location string. The other users may similarly vote for the same geographic coordinate or vote for other geographic coordinates if they disagree with a previous vote of another user.

Where multiple users (or a single user) may have changed which geographic coordinates correlate to a location string, in one embodiment, the geocoding platform 103 allows for the users (or user) to see the history of the changes to the correlation between the geographic coordinates and the location string. The history may include the original geographic coordinates that were selected as correlating to a location string (either by a user or by the geocoding platform 103), in addition to subsequent changes to the geographic coordinates (either by one or more users or by the geocoding platform 103). By way of example, the geocoding platform 103 may originally correlate location string A with geographic coordinates Z. User 1 may subsequently change the correlation such that the location string A correlates with geographic coordinates Y. Further, User 2 may subsequently change the correlation such that the location string A correlates with the geographic coordinates X, which may represent the current correlation. The geocoding platform 103 provides the ability for the users (e.g., Users 1 and 2) to see the changes to the correlation starting from Z, changing to Y and ending in X. The geocoding platform 103 may provide for the ability to sort the history according to any parameter, such as by user, by time, by geographic coordinates, and the like. In one embodiment, the results of user voting for geographic coordinates as correlating to a location string may automatically update the correlation, which may be indicated in the history.

In one embodiment, where the location string is associated with an event, one or more applications 111 at the UE 101, one or more services 109 and/or the geocoding platform 103 may allow users to check-in upon, for example, receiving a notification regarding the event and/or arriving at the location associated with the event. The geocoding platform 103 may then acquire contextual information associated with the users upon the users' check-ins to determine the geographic coordinates associated with the users (e.g., by use of GPS or other known location determination equipment/process). By way of example, a user may have created a calendar item (e.g., an appointment, a meeting, etc.) and entered a location string into a location field associated with the calendar item. The calendar item may also have, for example, an icon allowing for a user to indicate that the user is at the location and/or event associated with the calendar item, such as a check-in button. The user may select or activate the check-in button, which may cause the geocoding platform 103 to determine the current geographic coordinates of the user and associate the geographic coordinates with the location string. Where the calendar item and/or event is associated with other users, the geocoding platform 103 may also update the geocoding information associated with the other users. For example, a shared calendar item between a group of users may have the location field updated across all of the users based on the current location of a single user that checked-in.

Further, in one embodiment, the calendar item may also include timing information, such as when the calendar item will become active. Such timing information may represent, for example, a time prior to an event such that a reminder will activate to remind a user of the event, a time when the event will start, or the like. Where a reminder appears on, for example, a UE 101a associated with a user, the reminder may have a check-in button that allows the user to check-in to the event and allows the geocoding platform 103 to subsequently determine the geographic coordinates associated with the user at the time of the check-in. Further, in one embodiment, the calendar item may be shared with the geocoding platform 103. Upon satisfaction of the timing information, the geocoding platform 103 may determine the geographic coordinates associated with the one or more users who are associated with the calendar item to correlate the geographic coordinates with the location string within the calendar item.

A user selecting a check-in button may not necessarily mean that the user is currently at a location associated with where or when the user is checking-into an event and/or a location. Thus, in one embodiment, the geocoding platform 103 further allows a user to select another location associated with the event or location string upon the user checking-in that is not necessarily associated with the current geographic coordinates of the user. For example, the check-in may include a presentation of a map that may allow a user to select another location, other than the current location of the user, as the geographic coordinates that are associated with the check-in. Thus, where the user is not currently at the geographic coordinates associated with the check-in, but otherwise has a better sense of the geographic coordinates that are associated with the check-in, the user may indicate the accurate geographic coordinates associated with the check-in.

In one embodiment, the geocoding platform 103 may use one or more location trajectories to determine geographic coordinates that correspond with one or more location strings. The location trajectories may be determined based on contextual information associated with a user, such as contextual information associated with a user device. By way of example, the contextual information may be location information or any other contextual information that may be used to determine location information. The location trajectories may be traces of users' locations over time. The length of time that is used to define the location trajectories may be based on a threshold. The threshold may be determined based on contextual information, such as based on how fast the user is traveling, a general area that the user is in, etc. The length of time may also be defined by timing information associated with the event, such as a start time, an end time and/or a length of time. The geocoding platform 103 may then use the location trajectories to determine geographic coordinates that correspond with a location string.

By way of example, rather than the geocoding platform 103 determining the current location of a user when a user checks-in regarding a calendar item, the geocoding platform 103 may determine a location trajectory spanning back a set threshold and use the location trajectory to determine the geographic coordinates associated with the location string. When a location string is used by multiple users, such as when a location string is shared among users via a calendar item, the geocoding platform 103 may use location trajectories associated with the multiple users to determine the geographic coordinates associated with a location string. By way of example, as the multiple users check-in regarding the calendar item, the geocoding platform 103 may obtain or determine the location trajectories associated with the multiple users. In one embodiment, based on the location trajectories, the geocoding platform 103 may determine an average geographic coordinate associated with the location trajectories as a geographic coordinate associated with the location string. In one embodiment, based on the location trajectories, the geocoding platform 103 may determine an overlap of the location trajectories and use the overlap to determine the geographic coordinates that correlate to the location string.

In one embodiment, the geocoding platform 103 may use location trajectories of one or more users without requiring the users to check-in. For example, the geocoding platform 103 may determine timing information associated with a user, a location string and/or an event, such as when the user creates a calendar item with both a location string in a location field and timing information. Based on the timing information, the geocoding platform 103 may determine the location trajectories associated with the user starting based on the timing information, such as from the start of the timing information or from a threshold before or after the timing information. By way of example, if a user creates an appointment and enters a location string associated with the appointment in addition to a starting time associated with the appointment (e.g., timing information), the geocoding platform 103 may begin acquiring the location trajectory of the user from the starting time of the user or from a threshold period of time before the starting time. Further, when the location string is associated with multiple users, the geocoding platform 103 may determine location trajectories associated with the multiple users beginning according to the timing information, such as at the start time or a threshold period of time before the start time.

Where the geocoding platform 103 can determine multiple location trajectories associated with the same location string, such as when a group of users are associated with the same location string, the geocoding platform 103 may determine the location information, such as geographic coordinates, associated with the location string based on an overlap and/or intersection of the location trajectories, as discussed above. The overlap may be of all of the users or may be of a fewer number than all of the users. For example, if there are five users associated with a location string, the overlap may be between three of the five users, where the other two users may not have overlapping location trajectories, or where the other two users have overlapping location trajectories that are not associated with the other three users. Further, where the overlap is a point, the geocoding platform 103 may determine that point as the location information associated with the location string. However, the overlap may encompass more than a point, such as multiple points, multiple line segments, etc. In which case, the geocoding platform 103 may determine an area associated with the location information associated with the location string, such as a small radius encompassing the overlap of the location trajectories. The geocoding platform 103 may alternatively determine an average of all of the overlap and determine a point associated with the overlap as the geographic coordinates associated with the location string.

In one embodiment, where multiple users' location trajectories are used to determine the location information, the different users may have varying weights assigned to them and/or their associated location trajectories. The different weights may affect the overall determination of the location information based on the overlapping trajectories. The different weights may be assigned according to, for example, the different roles associated with the users related to an event that is associated with the location string. For example, the organizer of the event may be given the highest weight of all of the users since the organizer is generally always present at the location during the event and knows the location of the event. Mandatory attendees may similarly have as high or slightly less high weights as the organizer; while optional attendees or users that have not indicated that they will attend may be given the lowest weights.

The determination of the location information according to the location trajectories may be used separately or together with the manual inputs by the user. For example, an initial location determined by the geocoding platform 103 may be associated with one or more location trajectories. Subsequently, the geographic coordinates may be changed by the users by, for example, checking-in to the location associated with the location string, by manually changing the location by, for example, indicating the location on a map, or any combination of the methods discussed above. Further, the geocoding platform 103 may provide history information associated with the geocoding that includes the automatic geocoding performed by the geocoding platform 103 as modified by the user inputs.

In one embodiment, the determining of location information according to the geocoding discussed herein may be applied to other situations, such as business intelligence for location data learning and mining. By way of example, in one embodiment, a user may download a coupon onto a UE 101a. Subsequently, the user will likely go to a merchant that is associated with the coupon for the user to apply the coupon in a transaction. Further, the user will likely go to the merchant a few days or weeks after obtaining the coupon. The geocoding platform 103 may apply the location trajectories determined for users associated with downloading the coupon around the time of the users using the coupon to determine and/or verify the location information associated with the merchant's location that is associated with the coupon. The determined and/or verified location information may be subsequently used for geocoding by the geocoding platform 103.

Where a user associates a location string with location information, such as geographic coordinates, so that the association may be subsequently used for geocoding, the user may maintain the correlation between the location string and the geographic coordinates private to the user. Alternatively, the user may share the information to a group of users, or a group of users may share such information between each other, such as when the group of users is all associated with the same event. Further, the geocoding platform 103 allows for the correlation between a location string and location information, such as geographic coordinates to be shared among all users that use the geocoding platform 103. Further, at any point a user may adjust the privacy settings that a user assigns to a location string, such as private to only the user, a particular subset of a group of users, a group of users among all, or all of the users. Further, if the user modifies the location information that is associated with a location string, one or more of the modifications may have different privacy settings.

In one embodiment, the geocoding platform 103 allows for users to upload correlations between location strings and location information, such as geographic coordinates, to one or more services 109, one or more content providers 113, or one or more databases associated with the geocoding platform 103 and/or UE 101 such that other users, who may or may not be associated with the original user, can use the correlation. The user may upload the correlations by, for example, an SMS message, a MMS message, an email, etc. In one embodiment, human inspection of the correlations may occur before other users are able to use or take advantage of the correlation for geocoding identical or similar location strings. If the correlations are approved, the correlations may be accessible to all users of the geocoding platform 103. In one embodiment, users that upload correlations between location strings and location information may have different weights that affect approval of their correlations. For example, users that upload many accurate correlations may be weighted higher than users that only sometimes upload correlations that only sometimes are accurate. Further, in one embodiment, a user may be rewarded for contributing correlations between location strings and location information, such as by rewarding access to pay-for-services, redeemable gifts, etc.

Geocoding services have been traditionally associated with outdoor locations based on, for example, the inability of location services (e.g., GPS) to determine the locations of devices that are indoors. However, the functionality and processes discussed herein regarding the geocoding platform 103 are equally applicable to indoor geocoding where, for example, an indoor positioning system is available and has been integrated with the UE 101. For example, particularly for businesses, and even more particularly for large businesses that can potentially have large indoor work environments, meetings and appointments that are arranged related to the work environments may have location fields and corresponding location strings that correlate to specific areas and/or locations within the indoor workplace. The geocoding platform 103 may include correlations based on user input and/or contextual information between such location strings and location information pertaining to the indoor workplace.

In one embodiment, the geocoding platform 103 may be associated with and/or construct local knowledge bases specific to individual users and global knowledge bases that cover all of the shared correlations. The local knowledge bases may include the correlations that are specific to the user based on user created location strings and contextual information and/or user inputs that are specific to the user. The global knowledge base may include those correlations that are shared among the users. Thus, in one embodiment, for geocoding relative to each UE 101, the geocoding may be performed by the geocoding platform 103 based on either one of or both of the knowledge bases. The geocoding according to both of the knowledge bases may be performed either in parallel or in series. The series geocoding may be performed such as when the local knowledge base does not contain a correlation specific to a location string. When the geocoding occurs with respect to both knowledge bases, the returned results may be returned in order of similarity to a query of the location string.

By way of example, the UE 101, the geocoding platform 103, the services platform 107 and the content providers 113 may communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

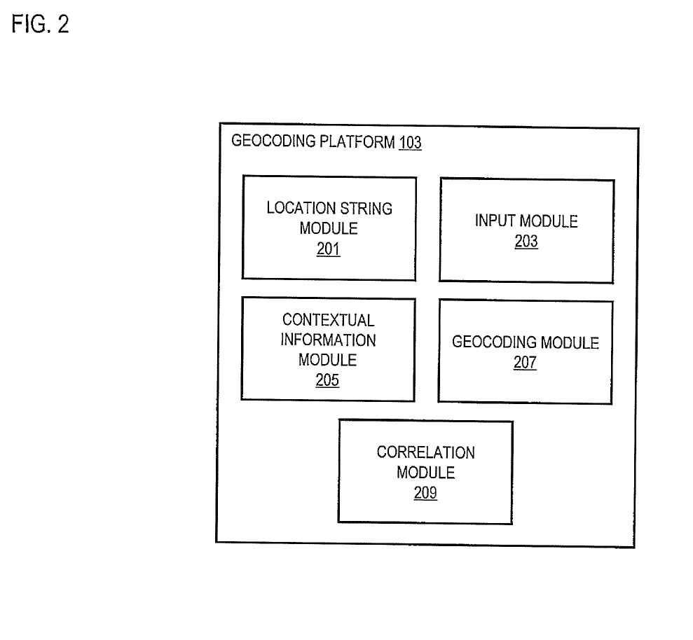

FIG. 2 is a diagram of the components of a geocoding platform 103, according to one embodiment. By way of example, the geocoding platform 103 includes one or more components for providing crowd-sourced location geocoding. It is contemplated that the functions of these components may be combined in one or more components or performed by other components of equivalent functionality. By way of example, one or more of the applications 111 at the UE 101 (e.g., the geocoding manager application 111a) may and/or one or more of the services 109 may entirely perform the functionality and/or the services discussed with respect to the geocoding platform 103. In this embodiment, the geocoding platform 103 includes a location string module 201, an input module 203, a contextual information module 205, a geocoding module 207, and a correlation module 209.

The location string module 201 may determine the one or more location strings that are associated with an event and the one or more users. The location string module 201 may determine the location strings based on, for example, the location strings being sent to the geocoding platform 103. In one embodiment, for example, one or more applications 111 at the UE 101 may be configured to send location strings to the geocoding platform 103 for geocoding. In one embodiment, one or more of the applications 111 at the UE 101 may be configured specifically to communicate location strings with the geocoding platform 103, such as a geocoding manager application 111a. In one embodiment, the geocoding manager application 111a may be executed at the UE 101 and may continuously, periodically, or on-demand search for one or more location strings associated with one or more other applications 111, one or more communications, etc. For example, a calendar application 111b may be executed at the UE 101 and may be used to create a calendar item. The calendar item may include a location field that includes a location string. The geocoding manager application 111a may determine the calendar item with the location field and extract the location string from the location field to send to the geocoding platform 103 such that the location string may be replaced with or combined with a hyperlink corresponding to the location information associated with the location string. As discussed above, such a hyperlink may be associated with a mapping application 111d that illustrates location information on a map at the UE 101.

Further, in one embodiment, the geocoding platform 103 may receive one or more location strings from one or more of the services 109 at the services platform 107. For example, one or more of the services 109 may be geocoding services that receive and/or supplement the geocoding information they determine from the geocoding platform 103. In response to one or more of the geocoding services 109 receiving a geocoding query, the geocoding services 109 may transmit the query (e.g., the location string) to the geocoding platform 103.

The input module 203 may receive the inputs from the users by way of the UE 101 associated with the users. In one embodiment, the one or more inputs associated with the users may come indirectly to the geocoding platform 103 from the UE 101 associated with the users, such as through one or more of the services. The inputs received and processed by the input module 203 may be any of the inputs discussed above with respect to the users. By way of example, where the geocoding platform 103 is unable to determine initial location information associated with a location string, and or determines location information corresponding to multiple locations, the input module 203 may receive one or more inputs from a user indicating, for example, the user's current position as the location information. The input module 203 may also receive one or more inputs in the form of votes from the users for determining the location information that corresponds to a location string. The input module 203 may also receive one or more inputs in the form of user check-ins for determining the location information that corresponds to a location string. The input module 203 may also receive one or more inputs associated with a user viewing and/or modifying a geocoding history associated with a location string. Further, the inputs received by the input module 203 may be in any form of input. By way of example, the input may be in the form of a character string, may be in the form of a graphic representation of a location with respect to a map, etc.

The contextual information module 205 acquires the contextual information associated with the one or more users that is used for geocoding the one or more location strings to determine the location information. The contextual information module 205 may acquire the contextual information directly from the UE 101. In which case, as discussed above, the UE 101 may include one or more sensors and or applications 111 for determining contextual information associated with the users, which may include contextual information associated with the UE 101. Such contextual information may include any type and/or kind of contextual information that is associated with a user, such as location information, which may include both past, current and predicted future contextual information. The contextual information may include, for example, the current location of a user, a location trajectory associated with a user, or any other contextual information that can be processed to determine a location of a user, such as one or more audio clips, one or more images, one or more videos, and the like.

The geocoding module 207 performs the functionality and the processes discussed herein for geocoding the one or more location strings to determine location information associated with an event and/or one or more users based the collected user inputs and the contextual information from the input module 203, and the contextual information module 205. In one embodiment, the geocoding module 207 may include one or more conventional geocoding processes that allow for a location string to be initially geocoded, which the geocoding module 207 may further geocode based on the user inputs and/or the contextual information associated with the user. In one embodiment, the geocoding platform 103 may communicate with one or more conventional geocoding services 109 for geocoding initial location information associated with one or more location strings, which the geocoding platform 103 may additionally geocode based on the user inputs and the contextual information.

The correlation module 209 may correlate the one or more location strings that the geocoding platform 103 processed with the location information that the geocoding information determined based on the user inputs and/or on the contextual information associated with the user. The correlation module 209 may correlate the location strings with the location information based on multiple categorization levels. By way of example, the correlation module 209 may correlate the location strings and the location information and store the correlations specific to the individual users that used or provided the location strings. Further, the correlation module 209 may correlate the location strings and the location information and store the correlations for a group of users, such as a group of users that were all associated with the same event and/or the same location string and that were thus associated with the same location information. Even further, the correlation module 209 may correlate the location strings and the location information and store the correlations for all of the users that are associated with the geocoding platform 103. In which case, the correlation module 209 may retain information regarding users that are associated with the geocoding platform 103 and that have requested the geocoding of location strings by the geocoding platform 103. The correlation module 209 may include one or more privacy settings such that the users can control the privacy settings for the location strings that have been correlated to location information based on the geocoding. The correlation module 209 may interface with one or more databases that are either local at the UE 101 or associated with the geocoding platform 103, one or more services 109 and/or one or more content providers 113. Thus, the correlation module 209 may store the correlations at only the UE 101 associated with the users, at only a global database associated potentially with all of the users (depending on privacy settings associated with the correlations), or may store the correlations both locally and at a global database.

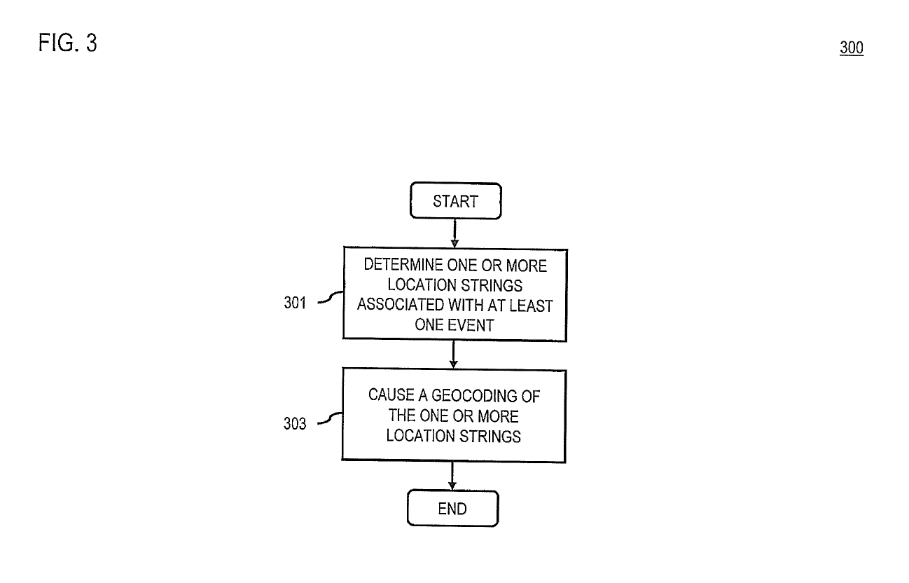

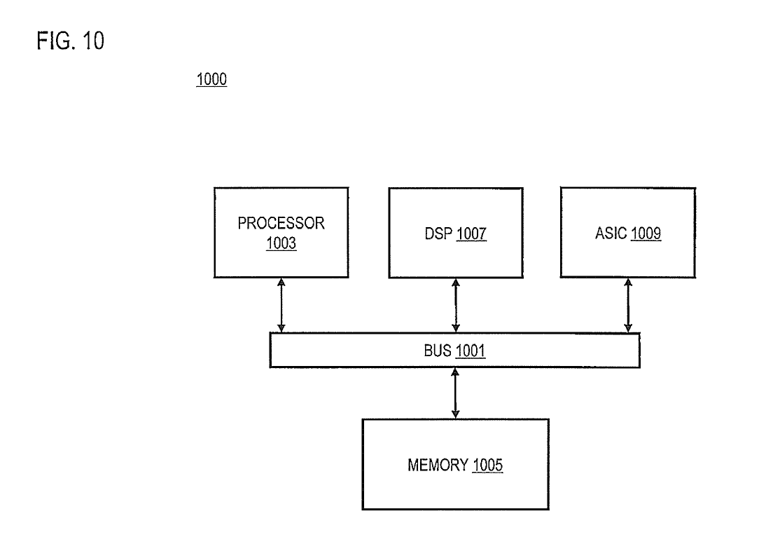

FIG. 3 is a flowchart of a process for providing crowd-sourced location geocoding, according to one embodiment. In one embodiment, the geocoding platform 103 performs the process 300 and is implemented in, for instance, a chip set including a processor and a memory as shown in FIG. 10. In step 301, the geocoding platform 103 determines one or more location strings associated with at least one event where the at least one event is associated with one or more users. As discussed above, the location strings may include one or more characters that describe location information. The location strings may be created by the user and thus be personalized descriptions of the location information. Alternatively, the location strings may be descriptions of location information according to one or more customary description formats. By way of example, the location strings may be formatted according to a postal address, such as by including a street number followed by a street, a city, a state and a zip code, where the location string is associated with a postal address in the United States of America. The location strings also may be less formal than a postal address, such as by merely including information regarding a landmark, a point-of-interest, etc. that may be associated directly and/or indirectly with location information. The location string may also be written as a note for a user such that the location string is only loosely tied to some form of indication of location information, such as being loosely tied to a postal address. By way of example, the location string may be “Grandma's house”. Further, the location string may be associated with an event that is associated with one or more users. Thus, at some point the one or more users will be at a location that corresponds to and/or is represented by the location string. For example, in the case of the calendar item above, the location string may refer to a meeting location point for multiple users associated with some event.

In step 303, the geocoding platform 103 causes, at least in part, a geocoding of the one or more location strings to determine location information associated with the at least one event based, at least in part, on one or more inputs, contextual information, or a combination thereof associated with the one or more users.

The one or more inputs, as discussed above, may include a user inputting location information, such as geographic coordinates and/or an icon on a map that can be translated to the geographic coordinates. The one or more inputs may also include, for example, one or more users voting with respect to what location information they believe correlates to the location strings. The one or more inputs may also include the one or more users indicating that they are at or near the location that corresponds to the location string, such as a user checking-in at the location. Based on any one or more of the user inputs, the geocoding platform 103 may determine the location information for geocoding the location strings. Although a location string may be entered by a user, and thus be considered a user input, for purposes of causing a geocoding of the one or more location strings to determine location information, the initial location string is not considered a user input.

The contextual information used by the geocoding platform 103 may be any type of contextual information that may be processed to determine location information for geocoding the location strings. In one embodiment, the contextual information may include a user's current location, which can be determined by one or more sensors associated with a UE 101a that is associated with the user. Such contextual information may be determined based on, for example, the user checking-in to a location corresponding to the location string. Further, such information may be based on, for example, the geocoding platform 103 determining timing information associated with the location strings and determining the contextual information based on satisfaction of the timing information. For example, when the location string was obtained from a calendar item, the calendar item may also include timing information. The geocoding platform 103 may determine the timing information and use the timing formation to determine when to determine the contextual information associated with a user, as discussed below. Further, the contextual information may be in the form of location trajectories that indicate a user's movement over a period of time. The location trajectories may be used to determine the location information, as discussed in detail below. Whether the geocoding platform 103 uses the one or more user inputs and/or the contextual information associated with the users, the geocoding platform 103 is able to determine location information from the location strings and the additional inputs and/or contextual information for geocoding the location strings.

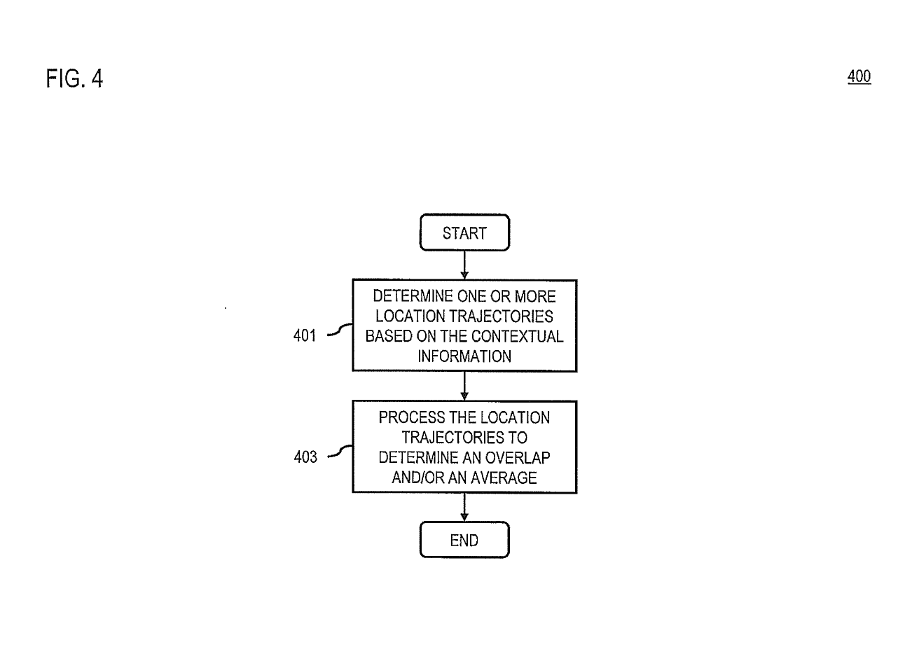

FIG. 4 is a flowchart of a process for providing crowd-sourced location geocoding based on one or more location trajectories, according to one embodiment. In one embodiment, the geocoding platform 103 performs the process 400 and is implemented in, for instance, a chip set including a processor and a memory as shown in FIG. 10. In step 401, the geocoding platform 103 determines one or more location trajectories associated with the one or more users based, at least in part, on the contextual information. The geocoding platform 103 may sample and/or collect locations of a user over a period of time and construct location trajectories. The location trajectories indicate the location of the user over the period of time. In one embodiment, the location trajectories may be represented by many different location points representing the location the user was when the location was determined. In one embodiment, the geocoding platform 103 may interpolate the points to determine a solid line representing the path of the user's movement during the period of time. In determining the location trajectories, the geocoding platform 103 determines not only, for example, a grouping of data points representing the locations of a user over a period of time. The geocoding platform 103 also determines the locations with respect to the time the locations were determined to represent the path of the user throughout the period of time.

At step 403, in one embodiment, the geocoding platform 103 may process and/or facilitate a processing of the one or more location trajectories to determine an overlap between at least two of the one or more location trajectories associated with the one or more users. Where there are multiple users and location trajectories determined based on the multiple users, an overlap may correspond to any number of the location trajectories overlapping, such as only two through all of the location trajectories overlapping. As discussed above, the overlap indicates that at least two users were at the same location with the period of time covered by the location trajectories. Further, in one embodiment, an overlap may indicate that at least two users were near the same location, but not necessarily at the same location, during the period of the location trajectories. For example, depending on the accuracy of the location determination, the location trajectories between two users may indicate that they came within five meters. For purposes of the geocoding platform 103, this may be considered as an overlap. However, the size of the area that is considered to determine an overlap may be of any threshold size, which may depend on, for example, the desired accuracy of the location information. Further, in one embodiment, an overlap may occur only when two or more users were at the same location (or an area) at the same time. Thus, although two location trajectories overlap, in one embodiment, the overlap may only be considered an overlap for purposes of determining location information if the overlap was the result of the users being at the same place at the same time.

At step 403, in one embodiment, the geocoding platform 103 may process and/or facilitate a processing of the one or more location trajectories to determine an average of the one or more location trajectories. The average of the location trajectories may consider all of the location trajectories and the corresponding locations, and average the locations to determine location information associated with a location string that is associated with the users and the location trajectories. The average may be determined based on only two of multiple users, or may be determined based on all of the users, or may be determined based on any combination in between. In one embodiment, for example, outliers are determined and are excluded from the determination of the average of the location trajectories. Such outliers may be determined according to any mathematical process for determining outliers within a subset.

In one embodiment, the average also may be determined considering weights associated with the users, and therefore associated with the corresponding location trajectories, such that some location trajectories are weighted more than others for determining the average. The weights may be assigned to the users according to, for example, the roles the users have associated with the event where, for example, the organizer of the event is weighted the highest, mandatory users of the event are weighted as high or slightly lower, down to users than have not yet confirmed their attendance to the event and/or are not mandatory to attend the event may be the lowest. Further, in one embodiment, at step 403, the geocoding platform 103 may determine both the overlap and the average. Under either approach, or according to both approaches, the geocoding platform 103 may subsequently use the location trajectories for determining location information in geocoding one or more location strings.

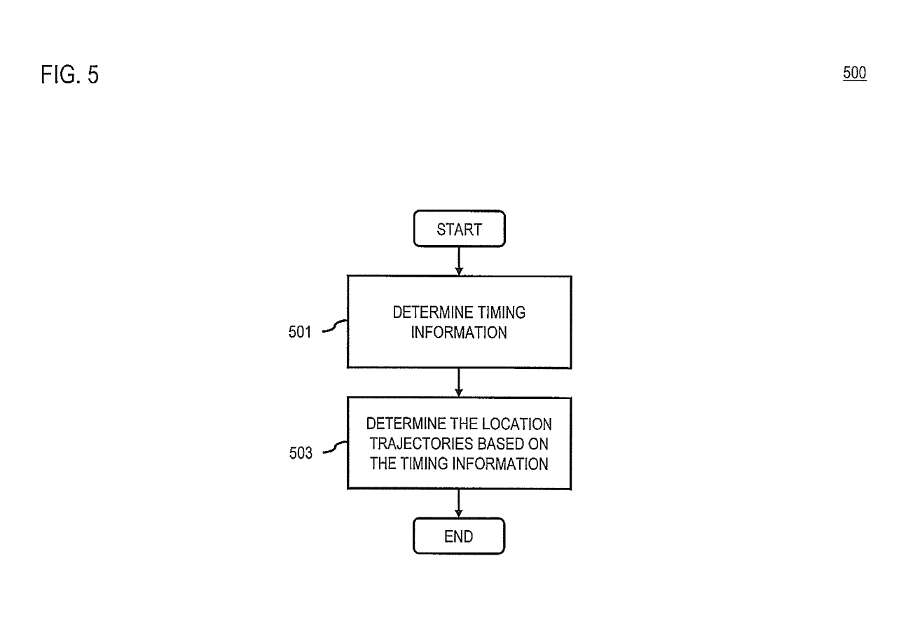

FIG. 5 is a flowchart of a process for determining location trajectories based on timing information, according to one embodiment. In one embodiment, the geocoding platform 103 performs the process 500 and is implemented in, for instance, a chip set including a processor and a memory as shown in FIG. 10. In step 501, the geocoding platform 103 determines timing information associated with the at least one event, the one or more location strings, or a combination thereof. In determining the location strings, the geocoding platform 103 also may determine timing information associated with the event and the users of the event. By way of example, as discussed above, where the location string is within a calendar item, the calendar item may include a location field with the location string and an additional field, such as a time field, that includes timing information for when the event will take place. The timing information may specify, for example, a start time, an end time, a length of time, or a combination thereof.

In step 503, the geocoding platform 103 determines the one or more location trajectories based, at least in part, on the timing information. Where the timing information includes a start time associated with the event, the geocoding platform 103 may determine the location trajectories based on a threshold period of time either before or after the start time. For example, for fifteen minutes before a start time the geocoding platform 103 may determine the location trajectories associated with the one or more users associated with the location string and the event. Alternatively, for fifteen minutes after the start time, the geocoding platform 103 may determine the location trajectories of the users. The location trajectories may be determined before the start time such that the overlap and/or average occurs as, for example, the users arrive to the location associated with the location string and the event. The location trajectories may be determined after the start time such that the overlap and/or average occurs as the users are at the location associated with the location string and the event. In one embodiment, the same approach associated with the start time may be used according to the end time.

Where the timing information includes a start time and an end time, or a start time and a length of time, the location trajectories may be determined based on the start time and be determined for the entire length of time associated with the event based on the end time and/or the length of time. The location trajectories also may be determined for any portion of the time associated with the event between the start time and the end time or end of the length of time, such as for one-half, one-quarter, three-quarters, etc. of the length of time.

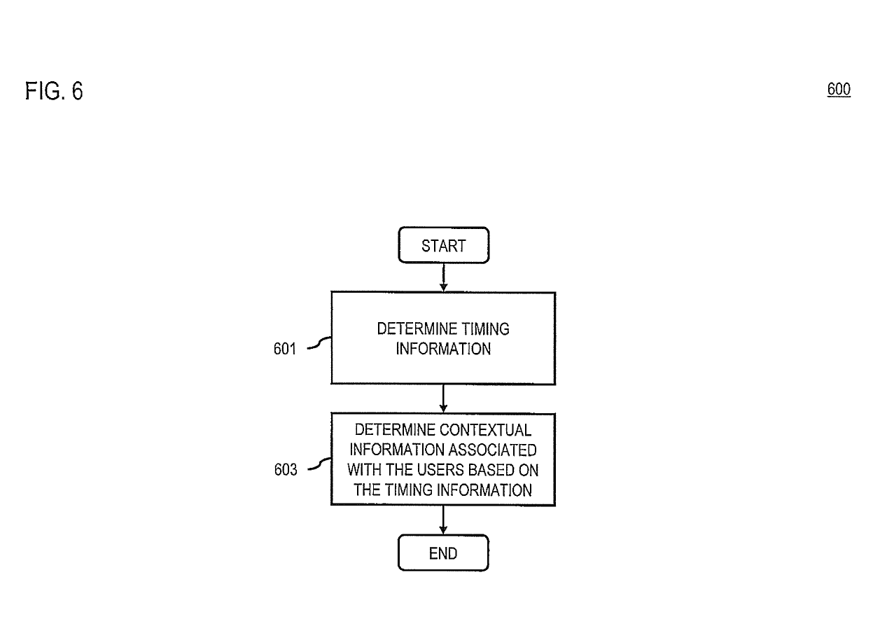

FIG. 6 is a flowchart of a process for determining contextual information based on timing information for providing crowd-sourced location geocoding, according to one embodiment. In one embodiment, the geocoding platform 103 performs the process 600 and is implemented in, for instance, a chip set including a processor and a memory as shown in FIG. 10. In step 601, the geocoding platform 103 may determine timing information associated with the at least one event, the one or more location strings, or a combination thereof in the same manner as discussed above with respect to step 501 in FIG. 5.

In step 603, the geocoding platform 103 may determine contextual information associated with the one or more users based, at least in part, on the timing information. The contextual information may be the location trajectories, as discussed above with respect to FIG. 4. However, the contextual information may be other information, including location information other than the location trajectories. For example, the contextual information may merely be the current location of the user at the start time of the timing information, such that the contextual information merely represents one location point. Thus, when the user is expected to be at the event, because the start time of the event has occurred, the geocoding platform 103 may determine the location of the user. The contextual information may be any other type of contextual information, such as the current barometric pressure associated with a user, the current velocity and/or acceleration of a user, etc. The contextual information may also be in the form of one or more audio clips, one or more images, one or more videos, and the like, that may be processed to correlate the audio, images, and/or video clips to a certain location. For example, a comparison of a database of images of known landmarks may be compared to an image taken by the user at the start time of the event to determine whether the user is near any known landmarks. The geocoding platform 103 may then use the contextual information to geocode the location string to determine location information associated with the location string.

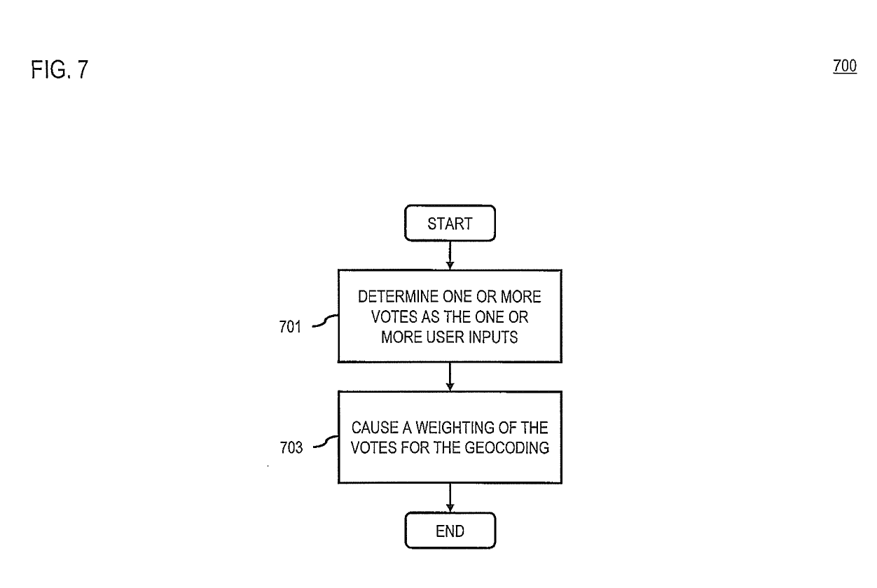

FIG. 7 is a flowchart of a process for providing crowd-sourced location geocoding based on one or more user votes, according to one embodiment. In one embodiment, the geocoding platform 103 performs the process 700 and is implemented in, for instance, a chip set including a processor and a memory as shown in FIG. 10. In step 701, the geocoding platform 103 determines one or more votes as the one or more user inputs associated with the one or more users that are based, at least in part, on the location information. As discussed above, the users associated with an event and location strings may vote on which location corresponds to the location correlated to a location string. Thus, rather than select a location, the user may vote regarding what the user thinks is the correct location. Based on a total number of users and/or a total number of votes, the geocoding platform 103 may determine location information associated with a location string for geocoding the location string. The geocoding platform 103 may take a location with a corresponding majority of votes, a corresponding plurality of votes, or according to any method of indicating which number of votes determines a corresponding selection of the location associated with the votes.

In step 703, the geocoding platform 103 may cause, at least in part, a weighting of the one or more votes according to a user associated with a vote. As discussed above, the users that vote may have different weights such that their corresponding votes counts more than votes by users with lower weights. For example, the vote by a user with the highest weight may count for 5 votes as compared to 1 vote for a user with the lowest weight. The weighting of the users may be determined based on, for example, the role of the user with respect to the event (e.g., organizer, mandatory, not mandatory, etc.). Thus, according to the weighting of the votes, the geocoding platform 103 may allow some users to affect the decision of the voting more than others.

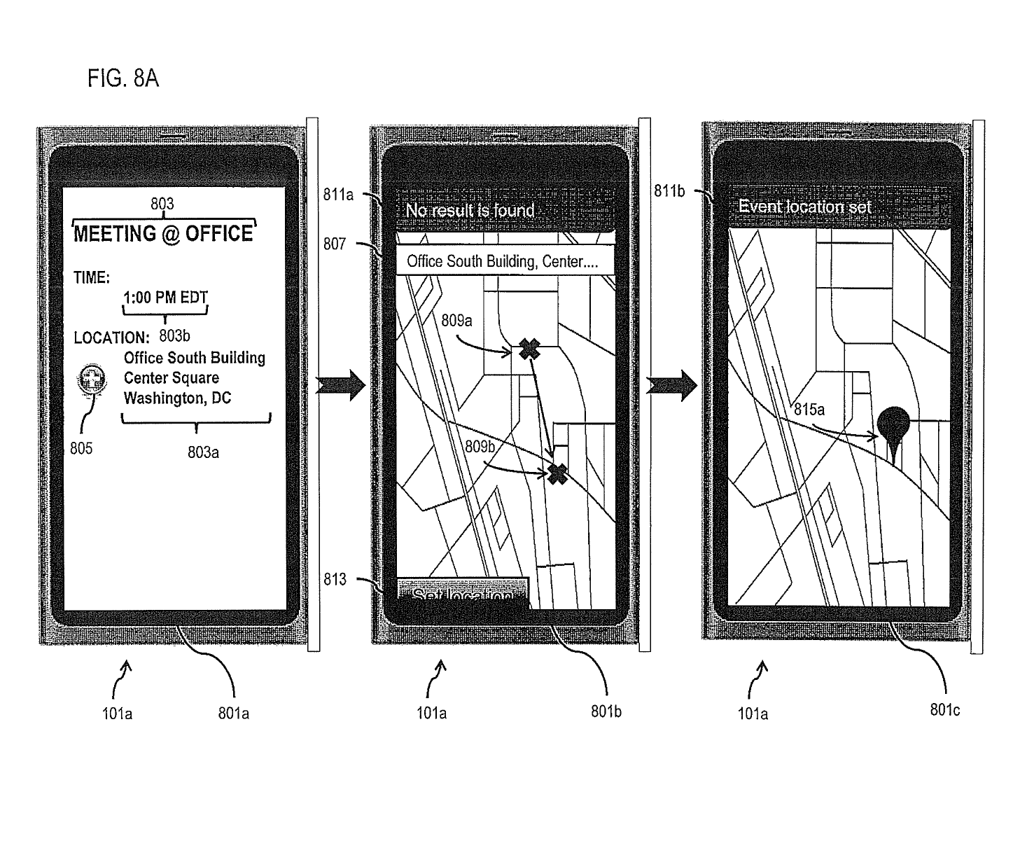

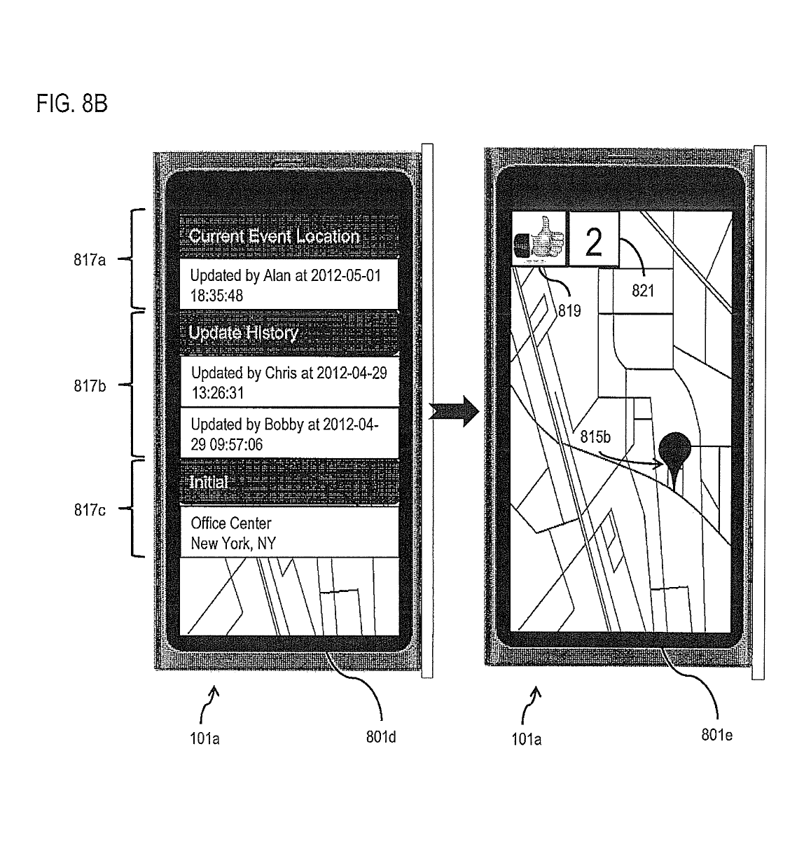

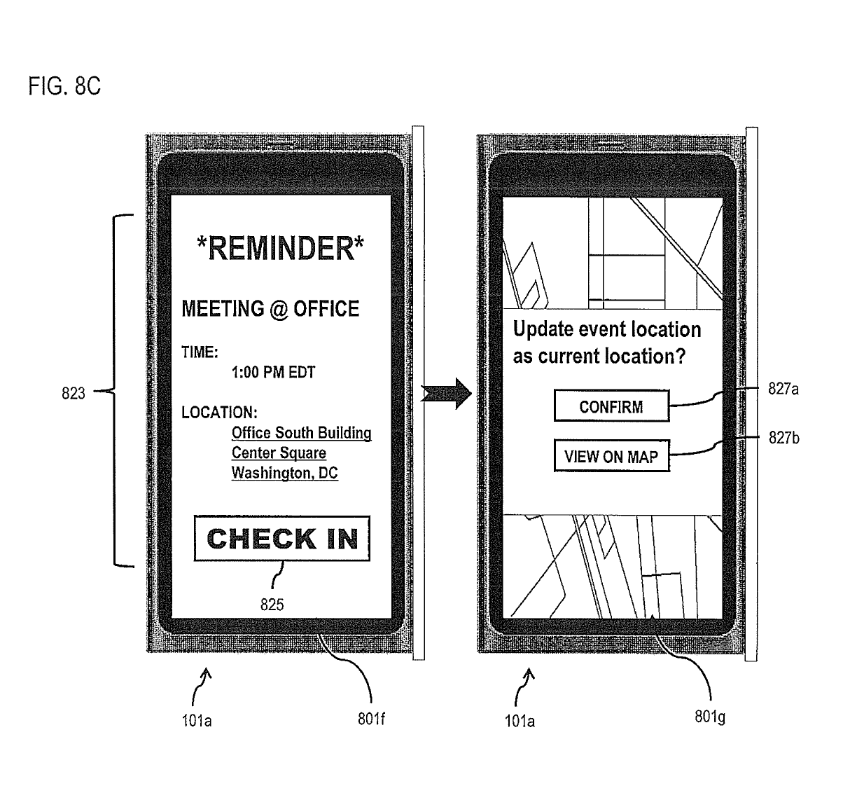

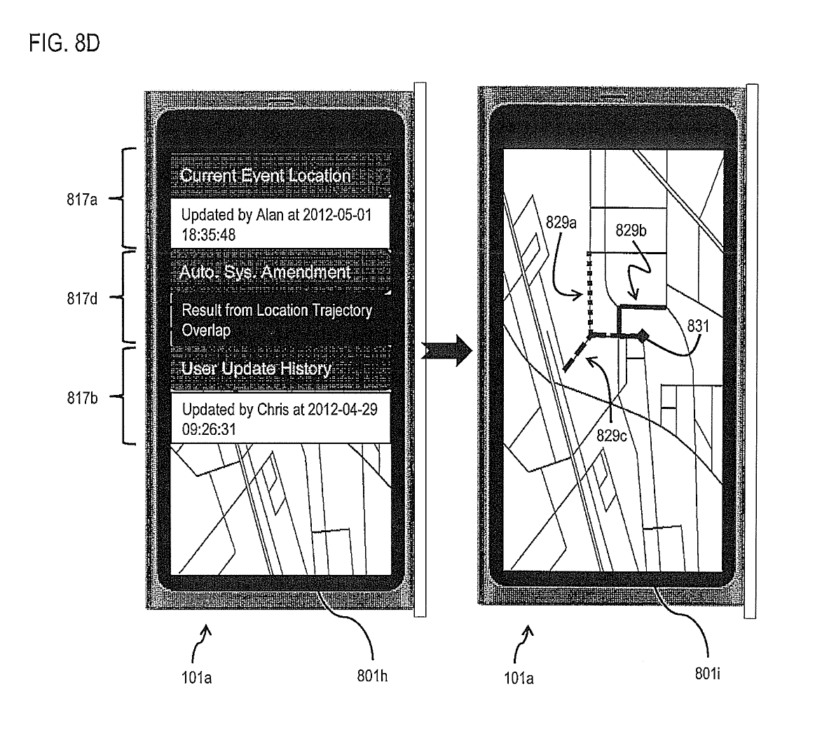

FIGS. 8A-8D are diagrams of user interfaces utilized in the processes of FIGS. 3-7, according to various embodiments. FIG. 8A illustrates a UE 101a with various user interfaces (801a-801c) associated with geocoding a location string. As illustrated in FIG. 8A, the UE 101a may initially display the user interface 801a related to creating a calendar item 803. By way of example, the calendar item 803 may represent an appointment that is stored within a calendar application 111b. The calendar item 803 may include a location string 803a that describes the location associated with the event corresponding to the calendar item 803. The calendar item 803 may also include timing information 803b. The geocoding platform 103 may initially be unable to geocode the location string 803a to determine the location information associated with the location string 803a (as illustrated, for example, based on the location string 803a not being underlined). Subsequently, the geocoding platform 103 may cause the indicator 805 to be displayed associated with the calendar item 803, or the indicator 805 may be displayed based on the calendar application 111b determining that the location string 803a was not properly geocoded. Upon, for example, a user selecting the indicator 805, the UE 101a may display the user interface 801b.

The user interface 801b allows a user to set a location, and thereby set location information, that is associated with the location string 803a. The indicator 807 may display the location string 803a, and the indicator 811a may indicate that there is currently no location information associated with the location string 803a. Further, the indicator 809a may represent an initial estimate of the location information. As discussed above, the initial estimate may be based on various methods, such as the current location of the UE 101a. Indicator 809b indicates a user input to adjust the location information associated with the location string to the accurate location. Upon changing the indicator 809a to the indicator 809b, the user may select the button 813 to set the location information associated with the indicator 809b as correlated with the location string. Thus, as indicated by user interface 801c, the indicator 811b illustrates that the event location associated with the location string has been set, and the indicator 815a illustrates the location information associated with the location string and according to the geocoding by the geocoding platform 103 based on the users input.

FIG. 8B illustrates a UE 101a with various user interfaces (801d and 801e) associated with geocoding a location string. As illustrated in FIG. 8B, the UE 101a may initially display the user interface 801d to allow a user to view the history of the correlation between the location string and the location information. Indicator 817a illustrates the current information that is associated with the location string, such as the user that modified the location information and the time of the modification. Indicator 817b illustrates the previous information that was associated with the location string, such as the users that modified the location information and the times of the modifications. Indicator 817c illustrates, for example, the initial location information that was associated with the location string. In one embodiment, a user may select any one of the edits and/or current event location to display the associated location information on the user interface. For example, user interface 801e may illustrate the set location 815b associated with the current location information in response to a user selecting the indicator 817a. In one embodiment, a user may vote for the location information by, for example, selecting the vote icon 819 if the user believes that the currently displayed location should correspond to the location string. Further, the user interface 801e may include an icon 821 that indicates the number of votes the currently displayed location has received.

In one embodiment, a reminder may be presented at the user interface of the UE 101a, as illustrated by the user interface 801f in FIG. 8C. The reminder 823 may include the information of the calendar item. Further, the reminder may include a “check in” button 825 that a user may select to check-in her current location as the location information corresponding to the location string. By way of example, if the user selects the “check in” button 825, the user interface 801g may appear and allow the user to select the “confirm” button 827a to confirm the user's current location as the location to associate with the location string. The user interface 801g may additionally include a “view on map” button 827b to allow the user to see her current location on a map to, for example, confirm the accuracy of the current location.

FIG. 8D illustrates user interfaces related to the geocoding platform 103 automatically making changes with respect to the location information related to geocoding a location string. For example, the user interface 801h illustrates the history of the location information that was associated with a location string for geocoding the location string. Indicators 817a and 817b are associated with the current location information and the previous update information, respectively. Further, user interface 801h includes the indicator 817d that indicates the geocoding platform 103 automatically updated the location information associated with a location string based on, for example, location trajectories that the geocoding platform 103 determined. A user may select the indicator 817d to view the location trajectories that the geocoding platform 103 used to determine the change in the location information.

The user interface 801i illustrates the location trajectories that were used to determine the location information associated with the automatic location information update. Specifically, user location trajectories 829a, 829b and 829c are location trajectories associated with, for example, three users that were used to determine the location information. For example, the geocoding platform 103 may have determined the location information associated with the location string based on where the three location trajectories overlap at the end of the timing information associated with the event. Thus, the geocoding platform 103 may have determined the geographic coordinates associated with the location 831 as the location information associated with the location string.

The processes described herein for providing crowd-sourced location geocoding may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

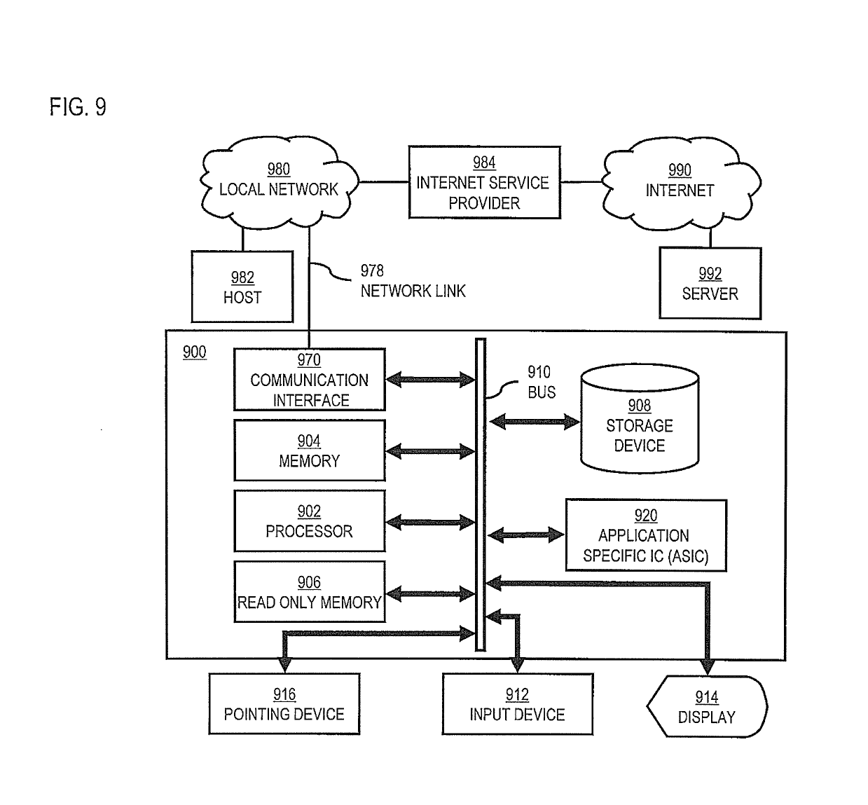

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to provide crowd-sourced location geocoding as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of providing crowd-sourced location geocoding.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to providing crowd-sourced location geocoding. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for providing crowd-sourced location geocoding. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing crowd-sourced location geocoding, is provided to the bus 910 for use by the processor from an external input device 912, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communications interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communications interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communications interface 970 is a cable modern that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for providing crowd-sourced location geocoding for the UE 101.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modern. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to provide crowd-sourced location geocoding as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of providing crowd-sourced location geocoding.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide crowd-sourced location geocoding. The memory 1005 also stores the data associated with or generated by the execution of the inventive steps.

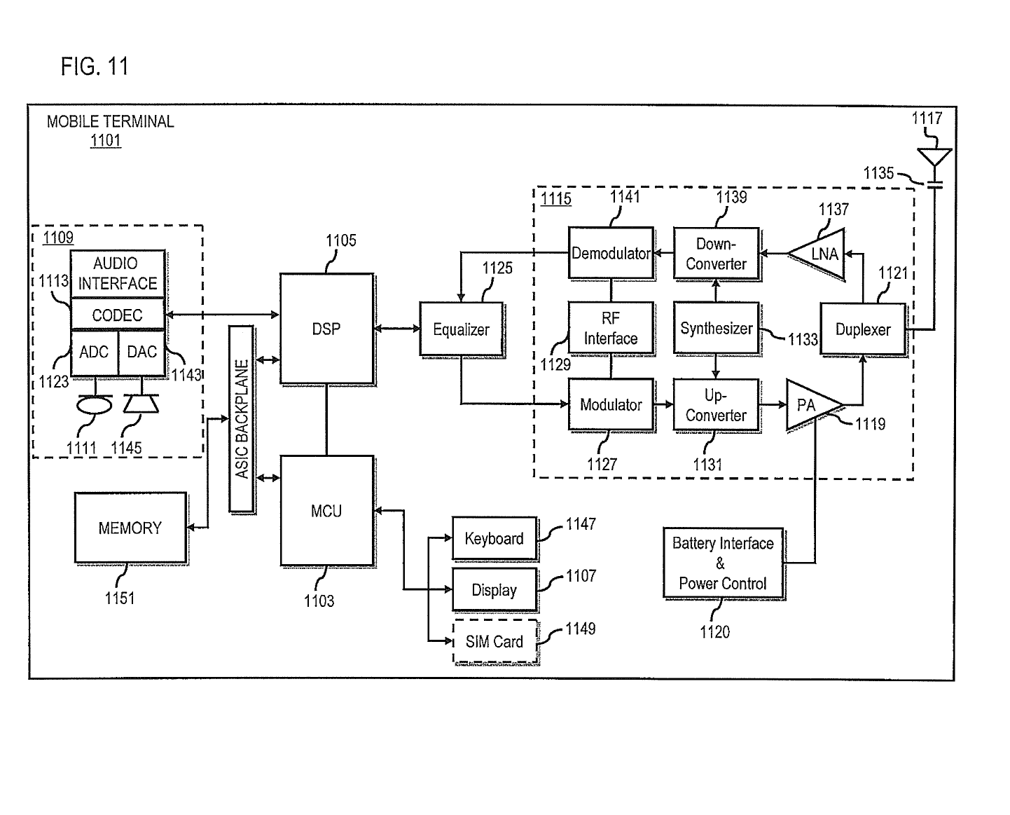

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of providing crowd-sourced location geocoding. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of providing crowd-sourced location geocoding. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to provide crowd-sourced location geocoding. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-53. (canceled)

54. A method comprising facilitating a processing of and/or processing (1) data and/or (2) information and/or (3) at least one signal, the (1) data and/or (2) information and/or (3) at least one signal based, at least in part, on the following:
one or more location strings associated with at least one event, wherein the at least one event is associated with one or more users; and
a geocoding of the one or more location strings to determine location information associated with the at least one event based, at least in part, on one or more inputs, contextual information, or a combination thereof associated with the one or more users.

55. A method of claim 54, wherein the (1) data and/or (2) information and/or (3) at least one signal are further based, at least in part, on the following:
one or more current locations associated with the one or more users based, at least in part, on the contextual information,
wherein the geocoding of the one or more location strings is based, at least in part, on the one or more current locations.

56. A method of claim 54, wherein the (1) data and/or (2) information and/or (3) at least one signal are further based, at least in part, on the following:
one or more location trajectories associated with the one or more users based, at least in part, on the contextual information,
wherein the geocoding of the one or more location strings is based, at least in part, on the one or more location trajectories.

57. A method of claim 56, wherein the (1) data and/or (2) information and/or (3) at least one signal are further based, at least in part, on the following:
a processing of the one or more location trajectories to determine an overlap between at least two of the one or more location trajectories,
wherein the geocoding of the one or more location strings is based, at least in part, on the overlap.

58. A method of claim 56, wherein the (1) data and/or (2) information and/or (3) at least one signal are further based, at least in part, on the following:
timing information associated with the at least one event, the one or more location strings, or a combination thereof; and
at least one determination of the one or more location trajectories based, at least in part, on the timing information.

59. A method of claim 58, wherein the timing information comprises a start time, or an end time, or a length of time, or a combination thereof, and the (1) data and/or (2) information and/or (3) at least one signal are further based, at least in part, on the following:
at least one determination of the one or more location trajectories based, at least in part, on a predetermined period of time before the start time or at least one determination of the one or more location trajectories based, at least in part, between the start time and the end time, during the length of time from the start time, or a combination thereof.

60. A method of claim 54, wherein the (1) data and/or (2) information and/or (3) at least one signal are further based, at least in part, on the following:
timing information associated with the at least one event, the one or more location strings, or a combination thereof;
contextual information associated with the one or more users based, at least in part, on the timing information; and
wherein the geocoding of the one or more location strings is based, at least in part, on the contextual information associated with the timing information.

61. A method of claim 54, wherein the (1) data and/or (2) information and/or (3) at least one signal are further based, at least in part, on the following:
one or more votes as the one or more user inputs associated with the one or more users that are based, at least in part, on the location information,
wherein the geocoding of the one or more location strings is based, at least in part, on the one or more votes.

62. A method of claim 54, wherein the (1) data and/or (2) information and/or (3) at least one signal are further based, at least in part, on the following:
a geocoding history associated with the location information based, at least in part, on the one or more inputs, the contextual information, or a combination thereof associated with the one or more users; and
a presentation of a rendering of the geocoding history at one or more devices associated with the one or more users.

63. A method of claim 54, wherein the (1) data and/or (2) information and/or (3) at least one signal are further based, at least in part, on the following:
one or more weights associated with the one or more users; and
a processing of one or more inputs associated with the one or more users based, at least in part, on the one or more weights.

64. An apparatus comprising:
at least one processor; and
at least one memory including computer program code for one or more programs,
the at least one memory and the computer program code configured to, with the at least one processor, cause the apparatus to perform at least the following,
determine one or more location strings associated with at least one event, wherein the at least one event is associated with one or more users; and
cause, at least in part, a geocoding of the one or more location strings to determine location information associated with the at least one event based, at least in part, on one or more inputs, contextual information, or a combination thereof associated with the one or more users.

65. An apparatus of claim 64, wherein the apparatus is further caused to:
determine one or more current locations associated with the one or more users based, at least in part, on the contextual information,
wherein the geocoding of the one or more location strings is based, at least in part, on the one or more current locations.

66. An apparatus according to any of claim 64, wherein the apparatus is further caused to:
determine one or more current locations associated with the one or more users based, at least in part, on the contextual information,
wherein the geocoding of the one or more location strings is based, at least in part, on the one or more location trajectories.

67. An apparatus of claim 66, wherein the apparatus is further caused to:
process and/or facilitate a processing of the one or more location trajectories to determine an overlap between at least two of the one or more location trajectories,
wherein the geocoding of the one or more location strings is based, at least in part, on the overlap.

68. An apparatus of claim 66, wherein the apparatus is further caused to:
determine timing information associated with the at least one event, the one or more location strings, or a combination thereof; and
determine the one or more location trajectories based, at least in part, on the timing information.

69. An apparatus of claim 68, wherein the timing information comprises wherein the timing information comprises a start time, or an end time, or a length of time associated with the at least one event, and the apparatus is further caused to:
determine the one or more location trajectories based, at least in part, on a predetermined period of time before the start time or determine the one or more location trajectories based, at least in part, between the start time and the end time, during the length of time from the start time, or a combination thereof.

70. An apparatus of claim 64, wherein the apparatus is further caused to:
determine timing information associated with the at least one event, the one or more location strings, or a combination thereof;
determine contextual information associated with the one or more users based, at least in part, on the timing information; and
wherein the geocoding of the one or more location strings is based, at least in part, on the contextual information associated with the timing information.

71. An apparatus of claim 64, wherein the apparatus is further caused to:
determine one or more votes as the one or more user inputs associated with the one or more users that are based, at least in part, on the location information,
wherein the geocoding of the one or more location strings is based, at least in part, on the one or more votes.

72. An apparatus of claim 64, wherein the apparatus is further caused to:
determine a geocoding history associated with the location information based, at least in part, on the one or more inputs, the contextual information, or a combination thereof associated with the one or more users; and
cause, at least in part, a presentation of a rendering of the geocoding history at one or more devices associated with the one or more users.

73. An apparatus of claim 64, wherein the apparatus is further caused to:
determine one or more weights associated with the one or more users; and
process and/or facilitate a processing of one or more inputs associated with the one or more users based, at least in part, on the one or more weights.
